(19) United States
(12) Patent Application Publication
(10) Pub. No.: US 2007/0050438 A1
(43) Pub. Date: Mar. 1, 2007

(54) Programmable digital filter

(75) Inventors: Roshan Samuel, Queen Creek, AZ (US); James E. Bartling, Chandler, AZ (US)

Correspondence Address: BAKER BOTTS, LLP, 910 LOUISIANA, HOUSTON, TX, 77002-4995, US

(73) Assignee: Microchip Technology Incorporated

(21) Appl. No.: 11/215,856

(22) Filed: Aug. 31, 2005

(51) Int. Cl. G06F 17/10

(52) U.S. Cl. 708/300

(57) ABSTRACT

A method of filtering one or more input signals, includes receiving one or more input signals, each having an input signal value. The method includes storing at least two instructions in a program memory to filter one or more of the input signals. Each instruction includes an opcode and identifies at least two input locations and at least one output location. The method includes, for one or more of the one or more input signals, and then for each instruction, fetching input values from the at least two input locations. The method further includes performing an operation on the input values to produce an output value, based on the opcode of the instruction and outputting the output value to at least one output location.

### TECHNICAL FIELD

The present disclosure, according to one embodiment, relates to filters used in digital systems, more particularly, to programmable digital filters.

### BACKGROUND

In signal-processing applications, there is a need to provide digital filters in different arrangements to produce desired output signals. In general, digital filtering is performed by devices arranged in parallel with a fixed number of poles. In such an implementations, dedicated hardware is provided to implement each stage in the digital filter. For example, FIG. 1 shows a third-order sinc filter with five stages, employing five adders. The first stage of the sinc filter 100 is an integration stage that includes an adder 105, a triggered register 110, and a register 115. The adder 105 receives inputs from an input port or register and the triggered register 110. The output of the adder is stored in a register 115 and, if the trigger signal (i.e., clk) is active, the output is further stored to the triggered register 110.

The second stage of the sinc filter 100 is another integration stage that includes an adder 120, a triggered register 125, and a register 130. The adder receives inputs from the register 115 and from a triggered register 125. The output of the adder 120 is stored in a register 130 and, when the trigger signal (i.e., clk) is active, the output is further stored to the triggered register 125.

The third stage of the sinc filter 100 is an accumulate and dump stage, which may be referred to as an integrate and dump stage in certain implementations. The accumulate and dump stage includes an adder 135, a triggered register 140, a register 145, and a latch 150. The adder 135 receives inputs from the register 130 and from the triggered register 140. The output of the adder 135 is written to the register 145. When the trigger signal to the latch (i.e., clk/64) is not active, but the trigger signal to the triggered register 140 (i.e., clk) is active, the output from the adder 135 is further written to the triggered register 140. When the trigger signal to, the latch (i.e., clk/64) is active the output from the adder 135 is further written to a register 155 and the triggered register 140 is cleared.

The fourth stage of the sinc filter 100 is a differentiation stage. The differentiation stage includes an adder 165, which is configured to perform subtraction, the register 155, and a triggered register 160. The inputs to the adder 165 are from the register 155 and the triggered register 160. The adder 165 is configured to subtract the value in the triggered register 160 from the value in the register 155. The result is stored in a register 170. When the trigger signal to the triggered register 160 (i.e., clk/64) is active, the value in the register 155 is stored in the triggered register.

The fifth stage of the sinc filter 100 is another differentiation stage that includes an adder 180, the register 170, and a triggered register 175. The adder 180 is configured to subtract the value in the register 170 from the value in the triggered register 175 and output the result to an output port or register. The value in the register 170 is stored in the triggered register 175 when the trigger signal to the triggered register (i.e., clk/64) is active.

The sinc filter 100 therefore requires five adders to implement a third order sinc filter and the components are set in a fixed arrangement. Certain applications, however, may require different types of filters (e.g., high pass, low pass, sinc, or other filters) at different times, depending on the application. Therefore, it is desirable to provide a programmable filter that may be reconfigured. It is also desirable to provide a filter with a variable number of poles (i.e., the order of the filter). Is also desirable to provide a filter without separate hardware (e.g., adders) dedicated to each of the filter stages.

### SUMMARY

The present invention overcomes the above-identified problems as well as other shortcoming and deficiencies of existing technologies by providing an apparatus, system, and method for serializing a multi-stage filter, thereby decreasing the number of components required to implement a multi-stage filter and providing a filter whose arrangement may be altered.

According to a specific example embodiment of this disclosure, a method of filtering one or more input signals is provided. The method includes receiving one or more input signals, each of which have an input signal value. The method includes storing at least two instructions in a program memory. The instructions, when performed serially by a programmable filter will filter the input signals. Each of the instructions includes an opcode and each instruction identifies at least two input locations and at least one output location. The method further includes looping once for one or more of the input signals. Within the loop, the method includes entering a second loop for each instruction. Within the second loop, the method includes fetching input values from the input locations. An operation is performed on the input values to produce an output value, based on the opcode of the instruction. The output value is then output to at least one output location.

According to another specific embodiment of this disclosure, a programmable filter may filter one or more input signals. The programmable filter includes a clock to provide a clock signal. The programmable filter also includes a single arithmetic logic unit (ALU) to selectively perform one of one or more operations on at least two input values and produce an output value. The programmable filter further includes a program memory for storing one or more instructions. Each of the instructions comprises an opcode and identifies at least two input locations and at least one output location. A scratch pad memory is coupled to the ALU to store one or more values. A trigger memory coupled to the ALU to store one or more values. At least one input register is coupled to the ALU to store an external input value. At least one output register coupled to the ALU to store an external output value.

The programmable filter includes a control unit coupled to the ALU and the program memory. The control unit receives an instruction from the program memory and based on the instruction, cause the ALU to receive two or more input values from one or more of the scratch pad memory, the trigger memory, and the at least one input register. The control unit also causes the ALU to perform a operation on the input values based on an opcode in the instruction to produce an output value. The control unit outputs the output value to one or more of the scratch pad memory, the trigger memory, and the at least one output register.

### BRIEF DESCRIPTION OF THE DRAWINGS

A more complete understanding of the present disclosure thereof may be acquired by referring to the following description taken in conjunction with the accompanying drawings wherein:

FIG. 1 is a schematic block diagram of a third order sinc filter with a parallel arrangement of adders;

FIG. 2 is a schematic block diagram of a programmable filter according to a specific example embodiment of the present disclosure;

FIG. 3 is a schematic block diagram of circuitry for providing trigger signals to the programmable filter according to a specific example embodiment of the present disclosure; and

FIGS. 4-9 are operational flow diagrams of a method for serializing one or more filters according to a specific example embodiment of the present disclosure.

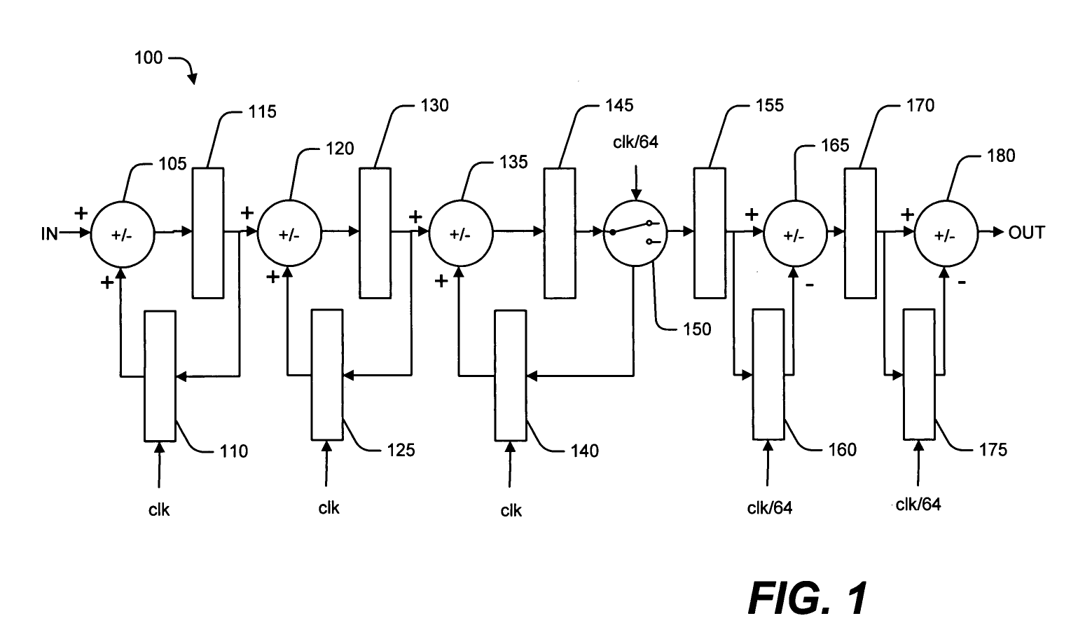

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

Referring now to the drawings, the details of example embodiments are schematically illustrated. Like elements in the drawings will be represented by like numbers, and similar elements will be represented by like numbers with a different lower case letter suffix.

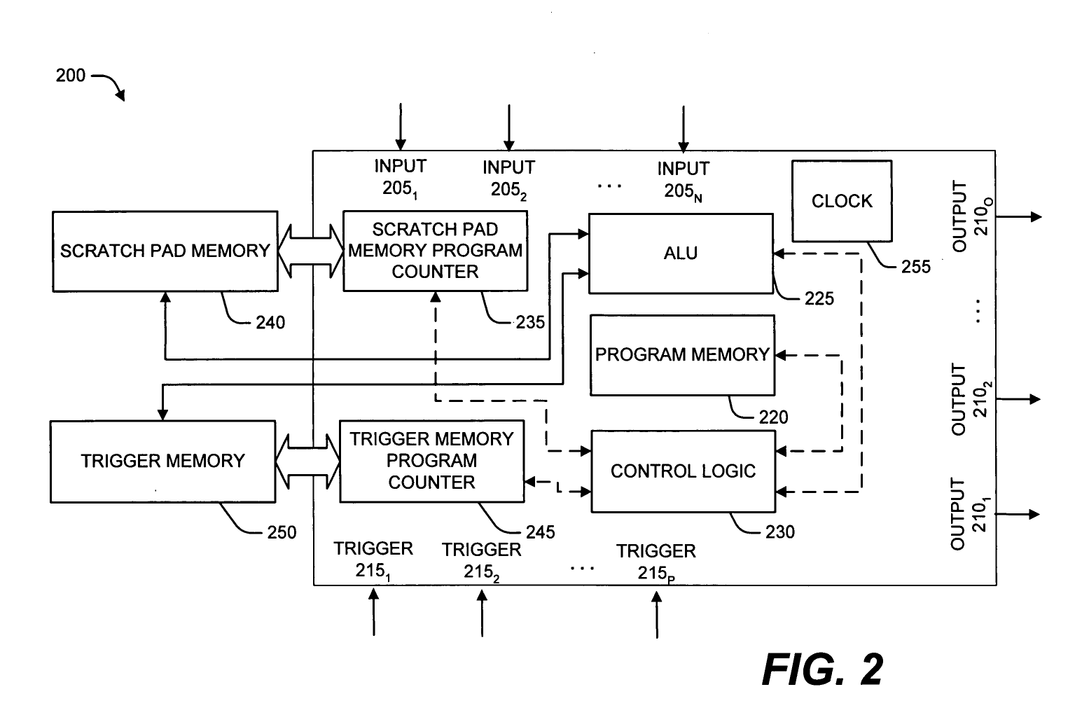

Referring to FIG. 2, depicted is a schematic block diagram of a programmable digital filter for serializing two or more filter stages, shown generally at 200, according to an example embodiment of the present disclosure. The programmable digital filter 200 includes N inputs 205_{1 . . . N}, which may be stored in registers. The programmable digital filter 200 includes O outputs 210_{1 . . . O}, which may also be stored in registers for retrieval by circuits outside of the programmable digital filter 200. The programmable digital filter 200 may also receive trigger signals on trigger inputs 215_{1 . . . P}, which may also be stored in registers. A program memory 220 is included in the programmable digital filter 200 to store one or more instructions for execution. The capacity of the program memory 220 may vary based on the needs of the programmable digital filter 200. In one example implementation, the program memory 220 may store 16-bytes of instruction to implement one or more digital filters. The instruction in the program memory 220 may be altered to implement different filtering operations. For example, at different times, the programmable filter 200 may provide a second-order high pass filer or a third-order sinc filter by loading different instruction in the program memory 220.

The programmable digital filter 200 further includes an arithmetic logic unit (ALU) 225 to perform one or more operations on one or more input values. In certain example implementations, the ALU 225 may selectively perform addition or subtraction of values stored in memory locations.

Certain implementations may feature more than one ALU, such as ALU 225. In general the programmable digital filter may include L ALUs. The plurality of ALU may be used to perform two or more stages of the filter in parallel. Such an implementation may allow the programmable digital filter 200 to run at a lower frequency, as multiple filtering stages may be performed in parallel. In some implementations, the number of ALUs used by the programmable digital filter 200 may be different from the number of stages of filtering. For example, the programmable digital filter 200 may use fewer ALUs than the number of stages of filtering. In certain implementations, the programmable digital filter 200 may use a single ALU 225.

The programmable digital filter 200 may be implemented in conjunction with a processor which may include one or more other ALUs. In some implementations, the processor may include the programmable digital filter 200, and use the programmable digital filter 200 to perform signal filtering operations. Such an implementation may allow the other ALUs in the processor to perform other functions while the programmable digital filter 200 performs signal processing operations.

The ALU 225 and the program memory 220 are coupled to control logic 230. The control logic fetches an interprets instructions stored in the program memory 220 and configures the ALU 225 to perform an operation on values stored in memory locations based on the contents of the instruction read from the program memory 220. The control logic is coupled to a scratch pad memory program counter 235 to point at a location in a scratch pad memory 240. The control logic 230 may control the value of the scratch pad memory program counter 235 to point at different locations in the scratch pad memory. For example, the control logic 230 may reset the scratch pad memory program counter 235 to point to the beginning of the scratch pad memory 240. In another example, the control logic 230 may increment the scratch pad memory program counter 235 to point to a next location in the scratch pad memory 240. In another example, the control logic 230 may read the scratch pad memory program counter 235 to determine a current location in the scratch pad memory 240. Likewise, the control logic may control or read the value of the trigger memory program counter 245.

Certain implementations may include a program memory location program counter to point to a current instruction in the program memory 220. In certain implementations, the control logic 230 may read the program memory program counter to determine the current instruction. In certain implementations, the control logic 230 may control the program memory program counter to, for example, advance to a next instruction in the program memory 220, or reset the program counter 220 to a first instruction in the program memory 220.

The scratch pad memory 240 may store values in one or more scratch pad memory locations. In certain example implementations of the programmable filter 200, the scratch pad memory locations each store a result that is output from the ALU 225. The size of the scratch pad memory 240 may vary based on the needs of the system. Furthermore, in certain example implementations the size of each of the scratch pad memory locations may vary to, for example, account for bit growth in various stages of the programmable digital filter 200. In other example implementations, the size of the scratch pad memory locations may be uniform. In one example implementation according to the present disclosure, the scratch pad memory 240 may be a 16×32 bit memory. The scratch pad memory 240 is coupled to the ALU 225 so that the ALU 225 may receive one or more values stored in scratch pad memory locations and so that the ALU may output results to one or more scratch pad memory locations.

The trigger memory 250 may store values in one or more trigger memory locations. In certain example implementations of the programmable filter 200, the trigger memory locations each store a result output from the ALU 225, but may only be written to when a trigger signal associated with the trigger memory location is active. The size of the trigger memory 250 may vary based on the needs of the system. Furthermore, in certain example implementations the size of each of the trigger memory locations may vary to, for example, account for bit growth in various stages of the programmable digital filter 200. In other example implementations, the size of the trigger memory locations may be uniform. In one example implementation according to the present disclosure, the trigger memory 250 may be a 16×32 bit memory. The trigger memory 250 is coupled to the ALU 225 so that the ALU 225 may receive one or more values stored in trigger memory locations and so that the ALU 225 may output results to one or more trigger memory locations. In certain implementations, trigger memory location values may be read regardless of the state of the trigger signal associated with the trigger memory location, but trigger memory location values may only be written when the trigger signal associated with the trigger memory location is active.

Although the scratch pad memory 240 and trigger memory 250 are described as two memories, in certain implementations they may be logical portions of the same physical memory device.

The programmable filter 200 includes a clock 255 to provide a clock signal to each of the components in the programmable filter 200. The speed of the clock 255 may be varied based on the needs of the system, in particular, the number of stages of the filter being serialized and the number of input signals. For example, to serialize the sync filer 100 for a single input signal, the system clock may run ten times faster than the sampling rate of the input signal. This rate allows the system to perform five memory loads/stores and five ALU operations within one sampling interval for the input signal. In general, for each stage of a filter to be serialized (e.g., for each instruction in the program memory 220), the system clock must operate twice as fast as the sampling rate for the input signal. The system clock rate may also be adjusted to account for the number of signals to be filtered. For example, if the programmable filter 200 was filtering four input signals (e.g., N=4), then the clock rate may be adjusted by a factor of four to account for the four signals to be filtered. In general, for implementations of the programmable digital filter 200 with a single ALU, the clock rate may be greater than or equal to 2×R×N×fₛ, where R is the number of instructions stored in the program memory, N is the number of input signals, and fₛ is the minimum sampling frequency of the one or more input signals.

In implementations of the programmable digital filer 200 that include a plurality of ALUs the clock frequency may be adjusted to account for the plurality of ALUs. In general, in such implementations, the clock frequency may be greater than or equal to

$$\frac{2 \times R \times N \times {f}_{S}}{L} ,$$

where R is the number of instructions stored in the program memory, N is the number of input signals, L is the number of ALUs used to filter the one or more input signals, and fₛ, is the minimum sampling frequency of the one or more input signals.

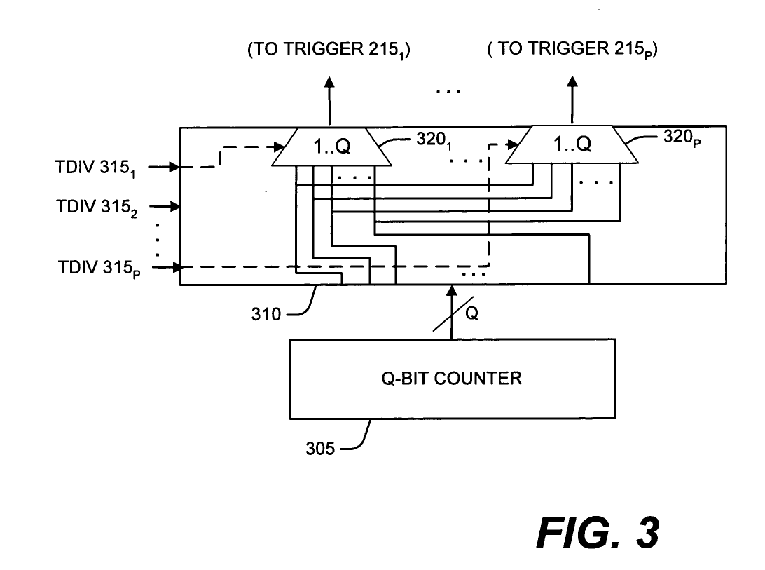

Referring to FIG. 3, depicted is a schematic diagram of a system to generate trigger signals 215_{1 . . . P}, for use with the programmable digital filter 200. The system may include a Q bit counter to generate Q bits in parallel. The number of signal may vary based on the needs and arrangement of the system. The Q bits may be input into time division circuitry 310 for generating the trigger signals from the Q bits. The time division circuitry may receive control signals TDIV 315_{1 . . . P} to control the time division circuitry. In the example implementation of the present disclosure shown in FIG. 3, the signals to TDIV 315_{1 . . . R} may control P multiplexers 320_{1 . . . P}. Each of the multiplexers 320_{1 . . . P} receives Q inputs from the Q bit counter 305 and outputs a trigger signal to one of the triggers 215_{1 . . . P}. In certain example implementations, each of the multiplexers 320_{1. . . P} are controlled by signals from one or more of TDIV 315_{1. . . P}. The signals to TDIV 3151_{1 . . . R} may be provided by the control logic 230. In one example implementation, the Q bit counter 305 is a 32 bit counter to generate 32 bits in parallel and each of the multiplexers 320_{1 . . . P} receives four control bits in parallel (e.g., TDIV 314₁ provides four control bits for multiplexer 320₁).

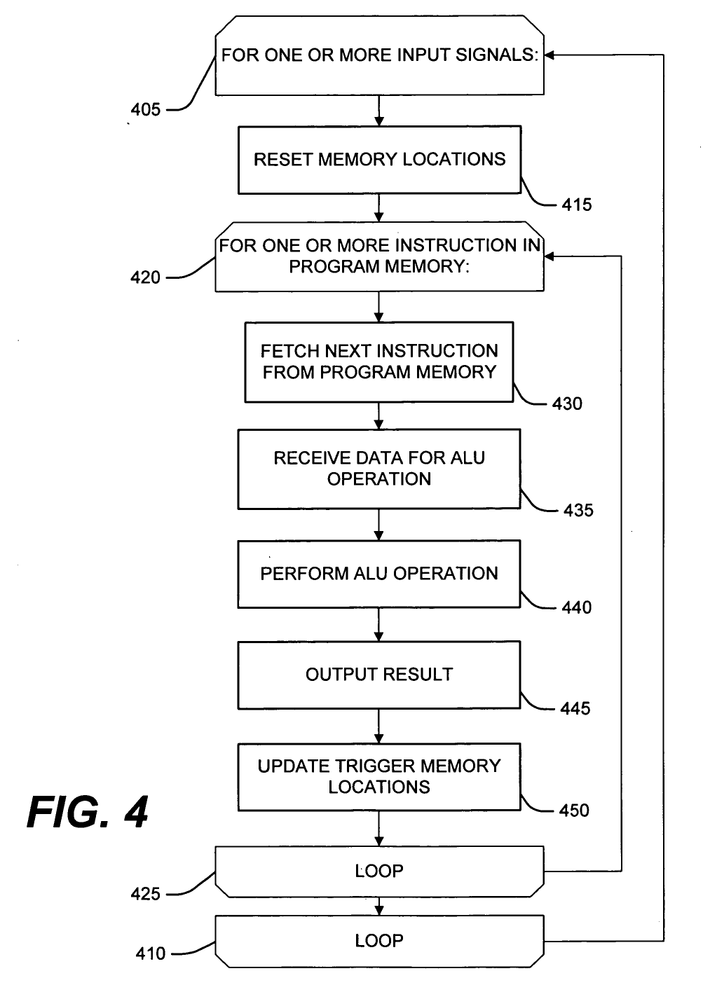

Referring to FIG. 4, depicted is an operational block diagram of the programmable filter 200 serializing two or more filter stages. The control logic 230 begins and enters a loop for one or more input signals on inputs 205_{1 . . . N} (blocks 405 and 410). Within this loop, the control logic 230 resets the memory locations (block 415). The programmable filter 200 then enters a loop for one or more of the instructions in the program memory 220 (block 420 and 425).

Within the loop defined by blocks 420 and 425, the control logic 230 fetches the next instruction from the program memory 220. In general each of the instructions represents one stage of the filter, such as the sinc filter 100. In certain implementations, each of the instruction in program memory includes an opcode that identifies the ALU operation to be performed. These opcode may include integrate (INT) to add one or more values, differentiate (DIFF) to subtract one or more values from another one or more values, or accumulate and dump (ACD) to add one or more values and reset to zero when an associated trigger signal is active. In certain implementations, accumulate and dump may be referred to as integrate and dump. Each of the instruction in the program memory identifies the locations of input values. The locations may include one or more input registers or input ports, such as inputs 205_{1 . . . N}, one or more scratch pad memory locations in the scratch pad memory 240, and one or more trigger memory locations in the trigger memory 250. Each of the instructions in the program memory further identifies one or more output locations to store the result. These output locations may include one or more output registers or ports, such as outputs 210_{1 . . . O}, one or more scratch pad memory locations in the scratch pad memory 240, or one or more trigger memory locations in the trigger memory 250. In general, each of the instruction in the program memory 220 are associated with one or more trigger signals, which may be applied to triggers 215_{1 . . . P}. The associated trigger signals may control whether results are stored to one or more trigger memory locations associated with the instructions. The associated trigger signals may further control whether the accumulate and dump instruction will reset a memory location.

After the control logic 230 has retrieved the program instruction from the program memory 220, it retrieves data for the ALU operation (block 435). Based on the instruction received in block 430, this may include configuring the ALU 225 to receive values from one or more scratch pad memory locations, one or more trigger memory locations, or one or more inputs 205_{1 . . . N}. Once the inputs are configured, the control logic 230 causes the ALU to perform an ALU operation based on the opcode in the instruction. The control logic 230 then outputs the result of the ALU operation to one or more locations, based on the instruction (block 445). The control logic 230 may then update one or more trigger memory locations (block 450).

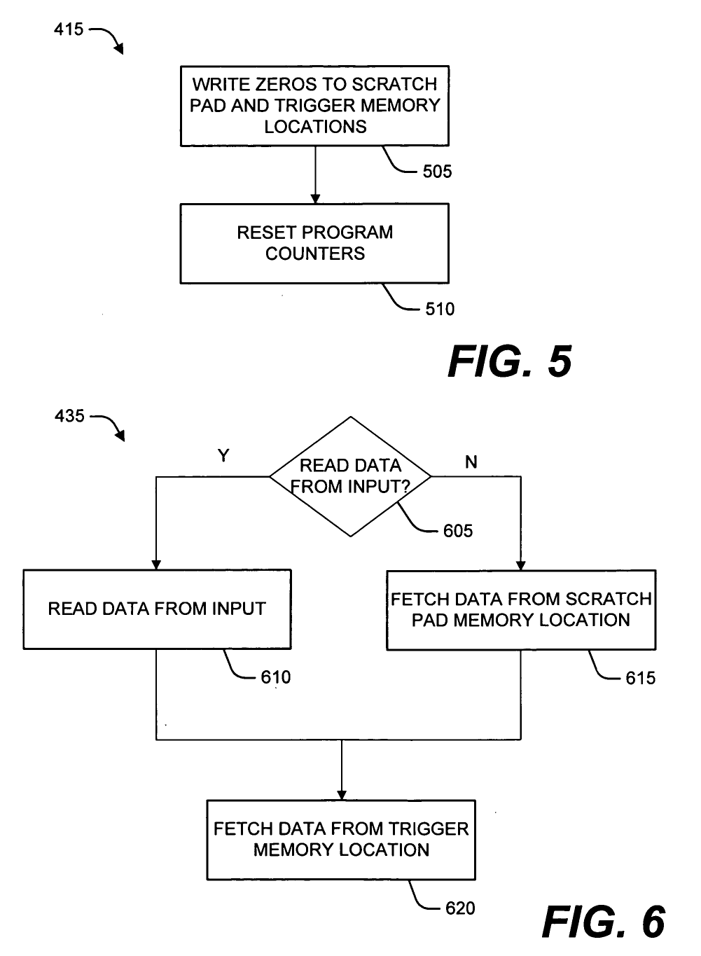

An example implementation of resetting the memory locations (block 415) is shown in greater detail in FIG. 5. Resetting the memory locations may include writing zeros to the scratch pad memory locations in the scratch pad memory 240 and the trigger memory locations in the trigger memory 250 (block 505). Resetting the memory locations may further include resetting the scratch pad memory counter 235 and the trigger memory program counter 245 (block 510).

An example implementation of receiving data for the ALU operation (block 435) is shown in greater detail in FIG. 6. If the instruction specifies that one of the inputs is from an input, such as inputs ²⁰⁵_{1 . . . N}, then the control unit 230 receives data from the specified input port or register (block 610). This may allow the programmable filter 200 to implement the first stage of the sinc filter 100, which requires an input value from outside the filter. If the instruction does not specify receiving an input value, the control unit will fetch data from a scratch pad memory location (block 615). Regardless of whether the control unit 230 receives an input from one or more of input ²⁰⁵_{1 . . . N} or scratch pad memory location, it will fetch an input value from a trigger memory location specified in the instruction (block 620).

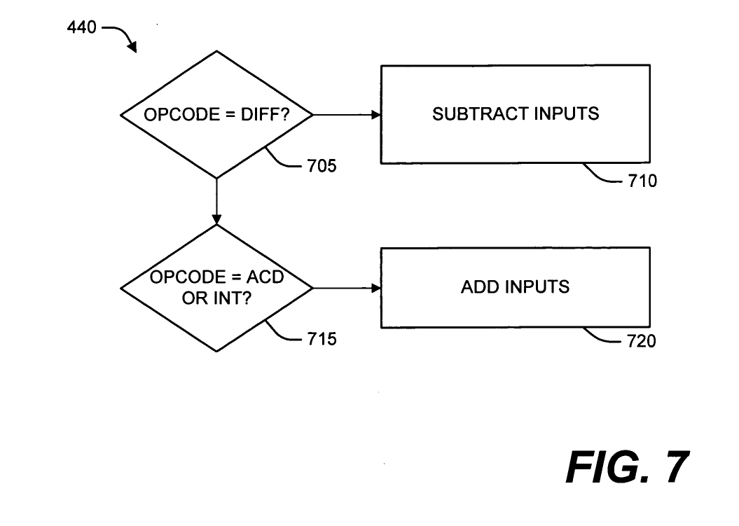

An example implementation of performing the ALU operation (block 440) is shown in greater detain in FIG. 7. If the opcode is differentiate (DIFF) (block 705), then the ALU 225 subtracts a second input from a first input (block 710). For example, when the programmable filter 220 is implementing the fourth stage of the sinc filter 100, it subtracts the input from the trigger memory location that corresponds to the triggered register 160 from the value in the scratch pad memory location that corresponds to the register 155. If the opcode is accumulate and dump (ACD) or integrate (INT) (block 715), then the ALU 225 adds the inputs (block 725). For example, when the programmable filter is implementing the second stage of the sinc filter 100, it adds the value in the scratch pad memory location corresponding to the register 115 with the value stored in the trigger memory location corresponding to the triggered register 125.

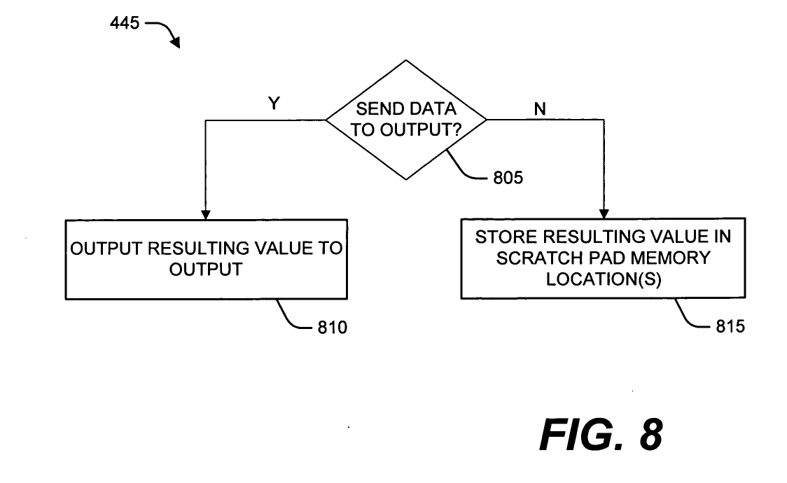

An example implementation of outputting the result from the ALU operation (block 445) is shown in FIG. 8. If the instruction being executed specifies sending data to an output port or register, such as one or more of output 410_{1 . . . M} (block 805), then the control unit 230 causes the ALU to output the result to the selected output ⁴¹⁰_{1 . . . M} (block 810). For example, when the programmable filter 200 is implementing the fifth stage of the sinc filter 100, the result of the ALU operation is sent to an output. Otherwise, the control unit 230 will cause the result of the ALU operation to be stored in one or more scratch pad memory locations (block 815). For example, when the programmable filter 200 is implementing the first stage of the sinc filter 100, the control unit will cause the result of the ALU operation to be stored in the scratch pad memory location corresponding to register 115. In the case of an accumulate and dump instruction, the scratch pad memory location written to may vary based on the value of the trigger associated with the accumulate and dump operation. For example, when the programmable filter is implementing the third stage of the sinc filter 100, and the trigger signal associated with the accumulate and dump operation is active, the result of the ALU operation is stored to the scratch pad memory location corresponding to register 155.

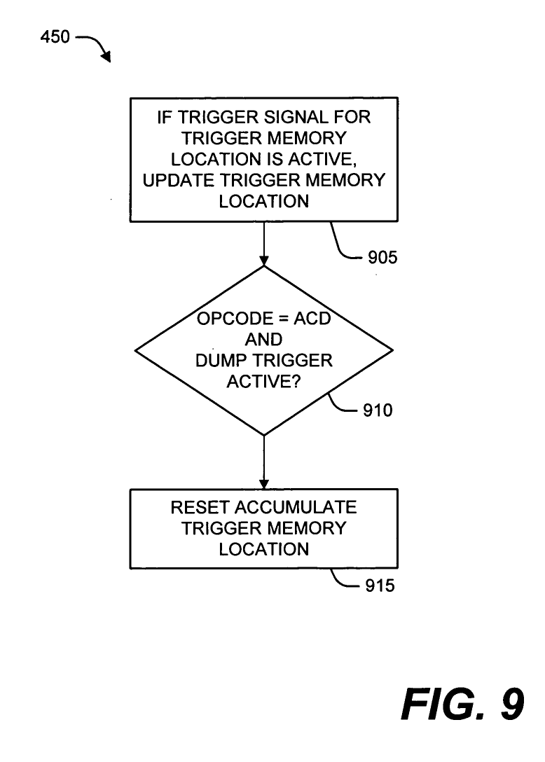

An example implementation of updating trigger memory locations (block 450) is shown in greater detain in FIG. 9. If the trigger signal corresponding to the trigger memory location is active the control logic 230 updates the trigger memory location (block 905). For example, when the programmable filter is implementing the second stage of the sinc filer 100 and the trigger signal for the trigger memory location corresponding to trigger register 125 is active, the result of the integrate (INT) operation is stored in the trigger memory location. If the opcode is accumulate and dump (ACD) and the trigger corresponding to the accumulate and dump is active (block 910), then the control logic 230 resets the value in the accumulate memory location. For example, when the programmable filter 200 is implementing the third stage of the sinc filter 100, it resets the value in the trigger memory location corresponding to the triggered register 140 to zero when the trigger signal associated with the accumulate and dump is active.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. A method of filtering one or more input signals, comprising:
receiving one or more input signals, each having an input signal value;
storing at least two instructions in a program memory to filter one or more of the input signals, each instruction comprising an opcode and identifying at least two input locations and at least one output location;
for one or more of the one or more input signals:
for each instruction:
fetching input values from the at least two input locations;
performing an operation on the input values to produce an output value, based on the opcode of the instruction; and
outputting the output value to at least one output location; and
where the operations are performed by fewer arithmetic logic units (ALUs) than the number of instructions.

2. The method of claim 1, where the input signals have a sampling have a maximum sampling frequency (fₛ), the method further comprising:
providing a clock signal, where the clock signal has a frequency that is at least 2×R×N×fₛ, where R is the number of instructions stored in the program memory and N is the number of input signals.

3. The method of claim 1, where the input signals have a sampling have a maximum sampling frequency (fₛ), the method further comprising:
providing a clock signal, where the clock signal has a frequency that is at least
$$\frac{2 \times R \times N \times {f}_{S}}{L} ,$$
where R is the number of instructions stored in the program memory, N is the number of input signals, and L is the number of ALUs used for filtering the one or more input signals.

4. The method of claim 1, where the operations performed by one or more ALUs that are dedicated to signal processing.

5. The method of claim 1, where the operations performed for each instruction are performed by a single ALU.

6. The method of claim 1, where fetching input values from at least two input locations comprises:
selectively fetching a first input value from one of a scratch pad memory location or an input register; and
fetching a second input value from a trigger memory location.

7. The method of claim 1, where outputting the output value to at least one output location comprises:
selectively storing the output value to one of a scratch pad memory location or an output register.

8. The method of claim 1, further comprising:
providing a trigger signal for one or more trigger memory locations, and where outputting the output value to at least one output location comprises:
storing the output value to a trigger memory location if the trigger signal for the trigger memory location is active.

9. The method of claim 1, where performing an operation on the input values to produce an output value comprises:
adding the input values in response to an integrate opcode.

10. The method of claim 1, where performing an operation on the input values to produce an output value comprises:
subtracting one or more of the input values from another one or more input values in response to a differentiate opcode.

11. The method of claim 1, further comprising:
providing a dump trigger signal for the ALU, and where performing an operation on the input values to produce an output value comprises:
in response to an accumulate and dump opcode:
adding the input values; and
if the trigger signal is active:
outputting the result to a first scratch pad memory location; and
resetting a trigger memory location;
otherwise:
outputting the result to a second scratch pad memory location.

12. A programmable filter for filtering one or more input signals, comprising:
a clock to provide a clock signal;
one or more arithmetic logic units (ALUs), each to selectively perform one of one or more filtering operations on at least two input values and produce an output value;
a program memory for storing one or more instructions, each instruction comprising an opcode and identifying at least two input locations and at least one output location;
a scratch pad memory coupled to one or more ALUs to store one or more values;
a trigger memory coupled to one or more ALUs to store one or more values;
at least one input register coupled to one or more ALUs to store an external input value;
at least one output register coupled to one or more ALUs to store an external output value; and
a control unit coupled to one or more ALUs and the program memory and adapted to:
receive an instruction from the program memory and based on the instruction, cause the one or more ALUs to:
receive two or more input values from one or more of the scratch pad memory, the trigger memory, and the at least one input register;
perform a filtering operation on the input values based on an opcode in the instruction to produce an output value; and
output the output value to one or more of the scratch pad memory, the trigger memory, and the at least one output register; and
where the number of ALUs is less than the number of instruction in the program memory.

13. The programmable filter of claim 12, further comprising:
one or more trigger inputs coupled to the control unit, each trigger input to receive a trigger signal, and where:
one or more locations in the trigger memory are each related to a trigger inputs; and
the control unit only allows the output value to be written to a location in the trigger memory when the related trigger input signal is active.

14. The programmable filter of claim 12, further comprising:
a program counter coupled to the control unit to point at a current instruction in program memory; and where the control unit is further adapted to control the program counter.

15. The programmable filter of claim 12, further comprising:
a scratch pad memory program counter to point at a current scratch pad memory location, and where the control unit is further adapted to control the scratch pad memory program counter.

16. The programmable filter of claim 12, further comprising:
a trigger memory program counter to point at a current trigger memory location, and where the control unit is further adapted to control the scratch pad memory program counter.

17. The programmable filter of claim 12, where each of the input registers receives a signal having a maximum sampling frequency (fₛ) and where the clock has a clock frequency that is at least as fast as
$$\frac{2 \times R \times N \times {f}_{S}}{L} ,$$
where R is the number of instructions stored in the program memory, L is the number of ALUs, and N is the number of input signals.

18. The programmable filter of claim 12, where the number of ALUs is 1.
